(19) United States
(12) Patent Application Publication
(10) Pub. No.: US 2005/0161267 A1
(43) Pub. Date: Jul. 28, 2005

(54) Fluid storage for fuel cell vehicles using closed section structural body rails

(76) Inventors: Gerald Elson, Rochester, MI (US); Christopher H. Williams, Grand Blanc, MI (US)

Correspondence Address: Kathryn A. Marra;300 Renaissance Center, Mail Code 482-C23-B21, P.O. Box 300, Detroit, MI, 48265-3000, US

(21) Appl. No.: 10/766,392

(22) Filed: Jan. 28, 2004

(51) Int. Cl. B60K 11/02; B60K 15/10; B62D 21/16

(52) U.S. Cl. 180/65.1; 180/69.5; 280/782

(57) ABSTRACT

The present invention is directed to a frame assembly for motor vehicle in which one of the frame elements utilized as a fluid storage volume. An elongated rail portion of the frame assembly defines a closed section which is utilized as a fuel storage volume for an operational fluid of the vehicle. In particular, the present invention is contemplated for use with a fuel cell based in which a fluid storage volume may be used for storing hydrogen, compressed air, water or alternately a cooling fluid. Furthermore, the elongated rail may be provided with various design features for storing a diverse operational fluid as well as adapt the elongated rail for conventional uses as an attachment point for various vehicle components or the routing of wire harnesses and fuel or brake lines.

### FIELD OF THE INVENTION

The present is directed to a frame assembly for a motor vehicle, and more particularly to an elongated rail within the frame assembly which is adapted to provide a fluid storage volume therein.

### BACKGROUND OF THE INVENTION

Significant efforts are being made to commercialize a hydrogen powered motor vehicle employing a fuel cell as the principle component of the power plant for the vehicle. This technology has significantly different design constraints from those encountered by vehicle designers of conventional internal combustion engines. One such parameter relates to the packaging of the various components within a fuel cell based vehicle. In this regard, a power train component of a fuel cell based vehicle may be generally more distributed about the frame assembly as compared with conventional internal combustion designs. Thus, a fuel cell based vehicle lends itself to a modular packaging concept over conventional vehicle designs. However, the number and mass of the components associated with a fuel cell based vehicle present new design challenges to the vehicle engineer.

One such challenge lies in providing an adequate source of the operational fluids for the fuel cell based power plant to achieve a suitable driving range for such a vehicle. Such operational fluids include the hydrogen-containing fuel and oxidant or air utilized as feed streams to the fuel cell stack for generation of electric energy. In addition, the operational fluid may include a cooling fluid to be circulated through the various components of the power plant to maintain the proper operational temperature thereof. Likewise, for vehicles which employ an on-board hydrogen reforming system, the operational fluids may further include a hydrocarbon-based fuel and a water utilized in the reforming process. An adequate source of each of these operational fluids must be provided on the vehicle to achieve the desired driving range.

Accordingly, there is a need in the art to provide an adequate fluid storage volume on board the motor vehicle while minimizing the packaging volume and additional mass associated with such storage volumes. As such, a fluid storage system which employs existing structure would provide such an improvement.

### SUMMARY OF THE INVENTION

The present invention is directed to a motor vehicle of the type having a frame assembly in which one of the frame elements are utilized as a fluid storage volume. More particularly, an elongated rail portion of the frame assembly having a closed section is utilized as a fluid storage volume for an operational fluid of the vehicle. In one embodiment, the fluid storage volume is a pressurized volume utilized for hydrogen storage to provide a source of hydrogen-containing fuel for a fuel cell based power plant. In another embodiment, the present invention is directed to a fluid storage volume for providing a source of compressed air to the fuel cell based power plant. In yet another embodiment, the present invention is directed to a fluid storage volume for providing a source of cooling fluid to the vehicle's power plant. In still another embodiment, the present invention is directed to a fluid storage volume for providing a source of water or steam for the vehicle's power plant.

Further aspects of the present invention are directed to the particular structural features of the elongated rail. More specifically, the internal volume of the elongated rail may be sectioned into discrete chambers for providing storage of diverse operational fluids. Alternately, the discrete chambers may be sealed from one another and utilized to provide an internal storage volume in addition to more conventional functions of the structural members such as providing a fastening surface for vehicle components and for routing support structure such as a wiring harness therethrough.

Further areas of applicability of the present invention will become apparent from the detailed description provided hereinafter. It should be understood that the detailed description and specific examples, while indicating preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 illustrates a first preferred embodiment of a motor vehicle incorporating a frame assembly in accordance with the present invention;

FIG. 2 is a cross-sectional view of an elongated rail of the frame assembly shown in FIG. 1;

FIG. 3 is a cross-section of an alternate embodiment of an elongated rail of the frame assembly shown in FIG. 1;

FIG. 4 is a cross-section of another alternate embodiment of an elongated rail of the frame assembly;

FIG. 5 is a cross-section of yet another alternate embodiment for an elongated rail of the frame assembly; and

FIG. 6 is a second preferred embodiment of a motor vehicle with a frame assembly in accordance with the present invention.

### DETAILED DESCRIPTION OF THE PREFERRED EMBODIMENT

The following description of the preferred embodiments is merely exemplary in nature and is in no way intended to limit the invention, its application, or uses.

With reference now to drawings, the present invention is directed to a motor vehicle generally indicated at reference number 10. The motor vehicle 10 has a frame assembly 12 which provides the primary support structure for the remaining components of the motor vehicle 10. A set of wheels 14 are rotatably supported from the frame assembly 12 in a conventional manner. A power train 16 is supported on the frame assembly 12 and is operably coupled to the wheels 14 through shaft 18. In this manner, power train 16 is operable to drive at least one of wheels 14.

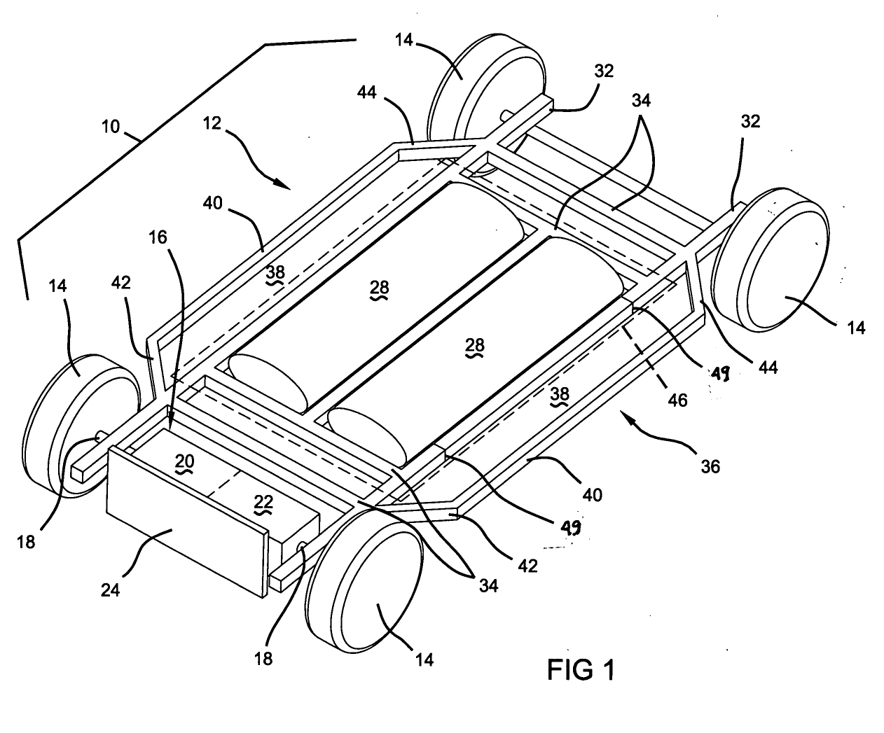

In the first preferred embodiment of the present invention illustrated in FIG. 1, the power plant 16 includes a fuel cell 20 operable to convert hydrogen and oxygen into electrical energy, and an electric motor 22 electrically connected to fuel cell 20 and operable to drivingly rotate shaft 18. In this regard, the motor 22 may include a transaxle gear assembly or other suitable drive train component for delivering rotary power to the wheels 14. A radiator 24 is supported near the front portion of the frame assembly 12. The radiator 24 is in fluid communication with the power train 16 such that a cooling fluid circulating therethrough functions to dissipate heat energy generated in the power plant 16. A pair of fuel tanks 28 are oriented in a generally longitudinal direction and supported on frame assembly 12. The fuel tanks 28 are in fluid communication with the power train 16 to provide a primary source of fuel in the form of a hydrogen-containing gas stream to fuel cell 20.

A second preferred embodiment of a motor vehicle 10′ is illustrated in FIG. 6. Motor vehicle 10′ is similar to motor vehicle 10 described above with the following exceptions. The power train 16′ of motor vehicle 10′ represents a distributed power train in that a drive motor 22′ is located adjacent each of the wheels 14′ and electrically coupled to the fuel cell 20′ by a series of wires forming a wiring harness 30′. Four fuel tanks 28′ are transversely oriented and supported on frame assembly 12′. The fuel tanks 28′ are in fluid communication with the fuel cell 20′ to provide a primary source of hydrogen feed gas thereto.

With reference to both FIG. 1 and FIG. 6, the frame assembly 12, 12′ includes a pair of longitudinal elongated frame rails 32, 32′ and a number of transverse, elongated cross rails 34, 34′ defining a generally ladder-type frame assembly 12, 12′. In this configuration, longitudinal rails 32, 32′ and cross rails 34, 34′ provide the primary structure and support for the remaining components of the motor vehicle 10, 10′. The frame assembly 12, 12′ further includes an auxiliary frame structure 36, 36′. The auxiliary frame structure 36, 36′ may perform various functions including providing attachment points for other components of the motor vehicle 10, 10′ such as the vehicle body (not shown). The auxiliary frame structure 36, 36′ may also define a crush zone 38, 38′. As illustrated in the figures, auxiliary frame structure 36, 36′ includes a pair of longitudinally oriented rails 40, 40′ extending generally parallel to frame rails 32, 32′. Front cross rails 42, 42′ and rear cross rails 44, 44′ connect the longitudinal rail 40, 40′ to longitudinal rail 32, 32′. Auxiliary frame structure 36, 36′ of the preferred embodiments are merely exemplary, and one skilled in the art will recognize that the auxiliary frame structure has a configuration dictated by the needs of a particular application.

As previously discussed, the present invention provides an effective use of the enclosed volume defined within the frame rail components 32, 32′, 34, 34′ of frame assembly 12, 12′ to provide a fluid storage volume generally indicated at reference number 46, 46′ of the figures. In this regard, one or more of the elongated rails 32, 32′ and 34, 34′ may define a closed section for providing the fluid storage volume 46, 46′. A single elongated rail portions may be utilized to provide the fluid storage volume. Alternately, multiple elongated rail portions may be in fluid communication with one another such that the fluid storage volume is defined within multiple elongated rail portions.

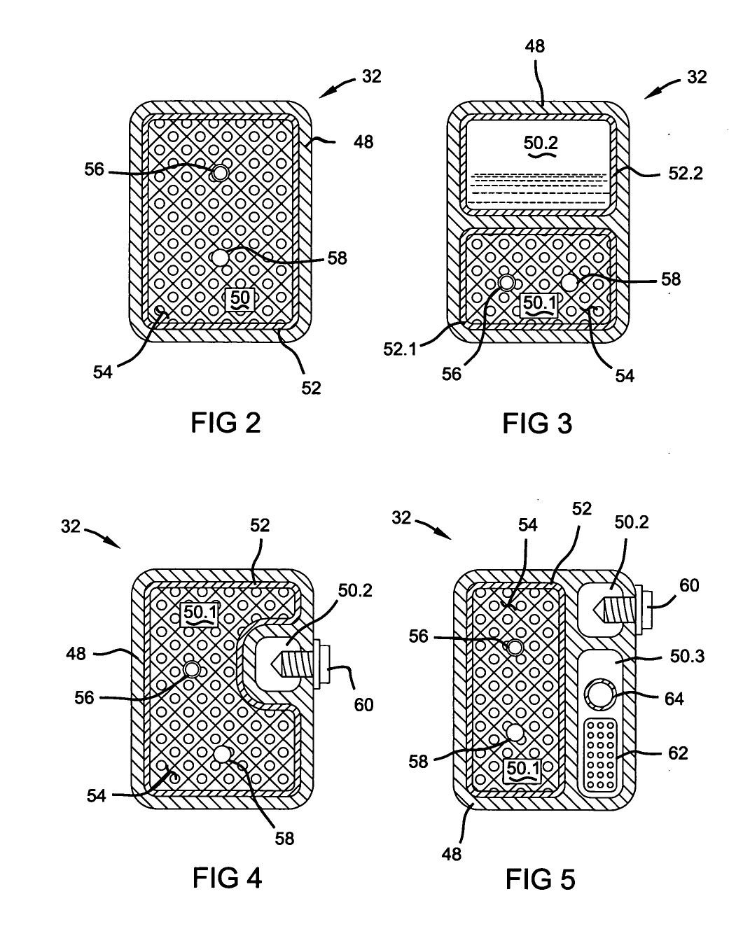

With reference to FIGS. 2-5, the cross-sectional configuration of an elongated rail providing the fluid storage volume is further described. It will be understood that the following discussion relates to any elongated rail portion such as longitudinal elongated rail 32, 32′ or transverse elongated rail portion 34, 34′. However, further reference will only be made to elongated rail 32.

Turning now to FIG. 2, elongated rail 32 is generally rectangular in cross-section having side wall 48 and end walls 49 (as shown in FIG. 1) which define a closed section therein. A liner 52 is formed on the interior surface of side wall 48 to seal the storage volume 50 within the elongated rail 32. The liner 52 may further function as insulation to prevent heat transfer from or to the ambient environment. Thus, the enclosed storage volume 50 is defined within liner 52.

In one aspect of the present invention, the fluid storage volume 50 may be adaptable as a rechargeable device to store and discharge hydrogen. Specifically, hydrogen is stored in a solid form and supplied as a gas when needed. To this end, the storage volume 50 is provided with a matrix 54 that form numerous open cells which have a solid hydrogen storage medium disposed therein. A tube 56 located within the storage volume 50 allows the hydrogen gas to transfer to and from the storage volume 50. A conduit 58 is also disposed within the storage volume 50 and allows a heat transfer fluid in the form of water, air, another liquid or gas suitable for transferring heat to and from the storage volume 50 to circulate therethrough. In this manner, the elongated rail 32 functions effectively as a pressurized hydrogen fuel storage volume. As presently contemplated elongated rail 32 functions as a reserve or supplemental fuel storage volume which is substantially less than the volume of the fuel tanks 28—in the range of less than 25% the capacity of fuel tanks 28. Further details concerning the use of a solid hydrogen storage median within the storage volume 50 is disclosed in U.S. Pat. No. 6,015,041, the disclosure of which is expressly incorporated by reference herein.

With reference now to FIG. 3, elongated rail 32 is generally rectangular in cross-section having a side wall 48 which divides the storage volume into discrete chambers 50.1, 50.2. Each of the chambers 50.1, 50.2 have a liner 52.1, 52.2 formed on its inner surface. As presently preferred, the first chamber 50.1 houses a solid hydrogen storage media 54, a port 56 and a conduit 58 as described above in reference to FIG. 2. The second chamber 50.2 provides a fluid storage volume separate and distinct from fluid storage volume 50.1. In this manner, the second chamber may provide storage of a second operational fluid which is diverse from the operational fluid stored in first chamber 50.1. For example, as illustrated, the second chamber 50.2 is adapted to store a liquid such as a cooling fluid or water usable by the power plant 16 of the motor vehicle 10.

With reference now to FIG. 4, elongated rail 32 is generally rectangular in cross-section having a side wall 48 providing a fluid storage volume 50.1 and a fastener channel 50.2. The fluid storage volume 50.1 is adapted to include a matrix 54 having a solid hydrogen storage media disposed therein, a port 56 and a conduit 58 as heretofore described. An insulating liner 52 is disposed on the inner surface of fluid storage volume 50.1. The fastener channel 50.2 defines an isolated fastener channel. In this manner, the fastener channel 50.2 is sealed from the fluid storage volume 50.1 such that a threaded fastener 60 may be secured through the side wall 48 of the rail 32 without disrupting or otherwise destroying the closed section of the fluid storage volume 50.1. In this configuration, the elongated rail 32 may be utilized as an attachment surface for various components of the motor vehicle 10 without disrupting the fluid storage volume 50.1 occupying the internal space within the elongated rail 32.

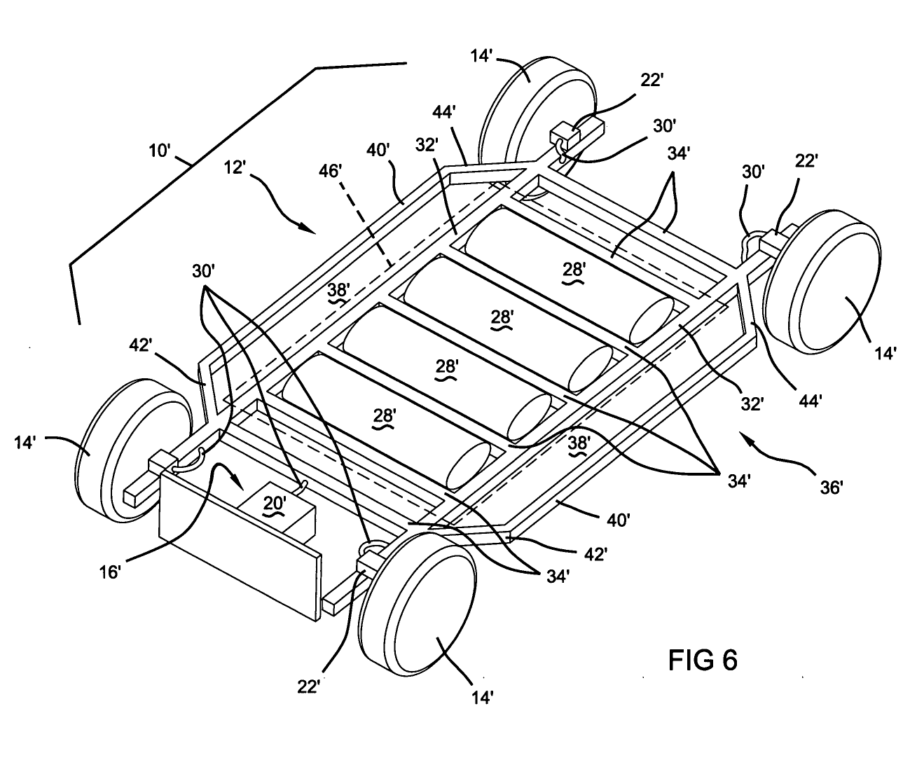

With reference now to FIG. 5, elongated rail 32 is generally rectangular in cross-section having a side wall 48 which defines a fluid storage volume 50.1, a fastener channel 50.2 and enclosed passageway 50.3. An insulating liner 52 is disposed within fluid storage volume 50.1. The fluid storage volume 50.1 has a matrix 54 with a solid hydrogen storage media disposed therein, a port 56 and a conduit 58 as heretofore described. The fastener channel 50.2 is formed in the elongated rail 32 similar to that described with reference to FIG. 4. In addition, an enclosed passageway 50.3 is provided in the elongated rail 32 which may be utilized for carrying vehicle components within the frame assembly 12. For example, a wiring harness 62 may be carried within passageway 50.3. Similarly, a tubular element 64 in the form of a fuel line or brake line may be disposed within passageway 50.3 for routing these elements within the frame assembly 12.

While the cross-sectional configurations shown in FIGS. 2-5 have been illustrated as generally rectangular, one skilled in the art will recognize that the particular cross-sectional configuration of the elongated rail will vary depending upon the location and structural requirements thereof within the frame assembly. Thus, the present invention contemplates that an elongated rail having a variety of cross-sections could be utilized within the present invention.

The description of the invention is merely exemplary in nature and, thus, variations that do not depart from the gist of the invention are intended to be within the scope of the invention. Such variations are not to be regarded as a departure from the spirit and scope of the invention.

1. In a motor vehicle of the type having a frame assembly, a set of wheels rotatably supported on said frame assembly and a power train operable to drive at least one of said set of wheels, the improvement comprising a fluid storage volume defined in an elongated rail portion of the frame assembly, said fluid storage volume being in fluid communication with said power train to provide an operational fluid thereto, said operational fluid being selected from the group consisting of a fuel, an oxidant and a cooling fluid.

2. The motor vehicle of claim 1 further comprising a fuel tank supported on said frame assembly and in fluid communication with said power train to provide a primary source of said fuel thereto such that said fluid storage volume is a reserve fuel tank.

3. The motor vehicle of claim 2 wherein said fluid storage volume is substantially less than said fuel tank by volume.

4. The motor vehicle of claim 1 wherein said operational fluid is compressed air.

5. The motor vehicle of claim 1 wherein said operational fluid is coolant.

6. The motor vehicle of claim 1 wherein said fluid storage volume has a first chamber and a second chamber, said first chamber in fluid communication with said power train to provide a first operational fluid thereto.

7. The motor vehicle of claim 6 wherein said second chamber is in fluid communication with said power train to provide a second operational fluid different from said first operational fluid.

8. The motor vehicle of claim 6 wherein said second chamber is a vacant chamber.

9. The motor vehicle of claim 1 wherein said fluid storage volume has a liner formed therein to seal said fluid storage volume.

10. The motor vehicle of claim 1 wherein said fluid storage volume is filled with a hydrogen storage media.

11. The motor vehicle of claim 1 where said at least one elongated rail portion comprises a longitudinal frame rail.

12. The motor vehicle of claim 1 where said at least one elongated rail portion comprises a cross frame rail.

13. The motor vehicle of claim 1 wherein said frame assembly comprises a plurality of elongated rail portions, said fluid storage volume being defined within at least two of said plurality of elongated rail portions.

14. A motor vehicle comprising:
a frame assembly including at least one elongated rail;
a power train supported on said frame assembly, said power train including a fuel cell operable to convert a hydrogen-containing fuel and an oxidant into electrical energy and a motor electrically connected to said fuel cell to convert said electrical energy into rotary movement of a shaft;
a radiator supported on said frame assembly, said radiator in fluid communication with said power train such that a cooling fluid circulates therethrough;
a set of wheels rotatably supported on said frame assembly, at least one of said set of wheels operably coupled to said shaft for driving said at least one of said set of wheels;
a fuel tank supported on said frame assembly and in fluid communication with said fuel cell to provide a primary source of said hydrogen-containing fuel thereto;
a fluid storage volume defined within said at least one elongated rail and in fluid communication with said power train to provide an operational fluid thereto, said operational fluid being selected from the group consisting of said hydrogen-containing fuel, said oxidant and said cooling fluid.

15. The motor vehicle of claim 14 wherein said operational fluid is said hydrogen-containing fuel.

16. The motor vehicle of claim 15 wherein said fluid storage volume substantially less than said fuel tank by volume.

17. The motor vehicle of claim 14 wherein said operational fluid is compressed air.

18. The motor vehicle of claim 14 wherein said operational fluid is coolant.

19. The motor vehicle of claim 14 wherein said fluid storage volume has a first chamber and a second chamber, said first chamber in fluid communication with said power train to provide a first operational fluid thereto.

20. The motor vehicle of claim 19 wherein said second chamber is in fluid communication with said power train to provide a second operational fluid different from said first operational fluid.

21. The motor vehicle of claim 19 wherein said second chamber is a vacant chamber.

22. The motor vehicle of claim 14 wherein said fluid storage volume has a liner formed therein for sealing said fluid storage volume.

23. The motor vehicle of claim 14 wherein said fluid storage volume is filled with a storage media.

24. The motor vehicle of claim 14 where said at least one elongated rail portion comprises a longitudinal frame rail.

25. The motor vehicle of claim 14 where said at least one elongated rail portion comprises a cross frame rail.

26. The motor vehicle of claim 14 wherein said frame assembly comprises a plurality of elongated rail portions, said fluid storage volume being defined within at least two of said plurality of elongated rail portions.
